(19) United States
(12) Patent Application Publication
(10) Pub. No.: US 2002/0040332 A1
(43) Pub. Date: Apr. 4, 2002

(54) Article ordering method, article order managing apparatus, and program storage medium

(75) Inventors: Koichi Maari, Chiba (JP); Yoshiaki Kagawa, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SONY CORPORATION, Shinagawa-ku (JP)

(21) Appl. No.: 09/962,103

(22) Filed: Sep. 26, 2001

(30) Foreign Application Priority Data
Sep. 27, 2000 (JP) 2000-294863

(51) Int. Cl. G06F 17/60

(52) U.S. Cl. 705/27; 705/26

(57) ABSTRACT

A user ordering a customized product accesses a product order managing center via an Internet using a user PC. Then, the user specifies a product, and transmits picture information such as a photograph to be copied onto the product to the product order managing center. The product order managing center generates picture information for displaying a virtual reality space that displays a three-dimensional graphics image picture of the customized product formed by copying a photograph or the like corresponding to the picture information onto the specified product, and then provides the picture information to the user PC via the Internet.

### BACKGROUND OF THE INVENTION

The present invention relates to an article ordering method using virtual reality space, an article order managing apparatus for receiving an order for an article from a user, and a program storage medium.

Conventionally, at a wedding reception, articles customized by a user, such as tableware on which a photograph or the like of a bride and groom is printed, are commonly presented. Also, when various ceremonies and the like other than wedding receptions are held, articles on which an original photograph or the like is printed may be used as a gift. In addition to the customized articles used as gifts, there is a desire to use a user-original article personally customized by a user, and also a desire to use an original article customized jointly by a plurality of users belonging to a group. Customized product sales service is therefore expected to continue to expand in the future.

There have recently been services put to practical use in which a customized product seller receives an order for a customized product from a user via the Internet, produces the customized product on the basis of the order, and then ships the customized product to the user. Use of the service makes it possible for the user to order a customized product easily without the trouble of going to a store.

In such services, a customized product can be ordered by following the steps below. First, the user accesses a Web page set up by the customized product seller using a personal computer (hereinafter referred to as a PC) that can be connected to the Internet. The user selects a desired product from a plurality of products (for example a mug, a T-shirt and the like) displayed on the Web page, and uploads picture information to be copied onto the selected product (such as picture information obtained by picture taking by a digital camera or picture information captured into the PC by a scanner or the like) to a specified server of the seller. As a result of such operation by the user, an order managing server of the seller receives an order for the customized product with the uploaded picture information copied at a specified position of the selected product. After thus receiving the order, a product fabrication factory or the like fabricates the product with the picture information copied thereon, that is, the product customized by the user, on the basis of information of the order received by the order managing server. The fabricated customized product is then delivered to the user.

Although the customized product sales service thus using the Internet may be used to order a product personally customized by an individual user, the customized product sales service is used in more cases to order a product customized by a group of a plurality of users. In such cases, each of the plurality of users belonging to the group would desire to decide whether or not to place an order after checking an image picture or the like of the customized product and consulting with the other user. However, with the above-mentioned customized product sales service using the Internet currently in operation, each of the users belonging to the group has to imagine the customized product by individually accessing the Web page set up by the customized product seller and then referring to a product image. Then, each of the users has to communicate with the other user by telephone or the like to decide whether or not to place an order. Thus, the process is complicated.

When shape of the product to be customized is simple, a user can imagine the product after customization to some extent by using imagination. When the shape of the product to be customized is complex, it is difficult to imagine the product after customization. In this case, the user needs to order the product without being able to accurately grasp an image of the product after customization. When the product is inexpensive, the user may order the product without being able to accurately grasp the image of the product. When the product is expensive, the user will naturally hesitate to order the product if unable to accurately grasp the image of the product to be customized.

### SUMMARY OF THE INVENTION

The present invention has been made in view of the above, and it is accordingly an object of the present invention to provide an article ordering method, an article order managing apparatus, and a program storage medium that make it possible to order a customized article easily, enable an image of the customized article to be grasped more accurately by the orderer, and simplify operations when the article is customized jointly by a plurality of users.

In order to solve the above problems, according to the present invention, the following steps are followed when placing an order for an article customized by users of a plurality of user terminal apparatus connected to a network with an article order managing system having a virtual space providing server for providing a virtual reality space to a plurality of the user terminal apparatus via the network. First, customizing information for customizing the article is transmitted from the user terminal apparatus to the article order managing system via the network. When the article order managing system receives the customizing information, the virtual space providing server generates picture information of a virtual reality space displaying the article customized on the basis of the received customizing information. Thereafter, the generated picture information is transmitted from the virtual space providing server via the network to the user terminal apparatus that have logged in to the virtual reality space, whereby the virtual reality space displaying the customized article is displayed on the user terminal apparatus to prompt for an order for the customized article. Then, order indicating information indicating the order for the article displayed in the virtual reality space is transmitted from the user terminal apparatus to the article order managing system via the network.

After the user transmits the customizing information to the article order managing system using the user terminal apparatus, the virtual space providing server generates picture information of the virtual reality space displaying the article customized on the basis of the customizing information transmitted by the user, that is, information on how to customize the article, and thereafter the picture information is transmitted to the user terminal apparatus that have logged in to the virtual reality space. The customized article is thereby displayed on the user terminal apparatus that have logged in to the virtual reality space. Therefore, the user can grasp an image of a finished customized article more accurately, and thus properly determine whether or not to order the article. Since the user can grasp the image of the customized article more accurately before ordering the article, the user may order the article when the user is satisfied with a finished state of the article. Therefore, it is possible to prevent hesitation of the user in ordering an expensive article due to inability of the user to imagine a finished state of the article. In addition, since the customized article is displayed on the user terminal apparatus that have logged in to the virtual reality space, even in a case where a plurality of users jointly order the customized article, each of the users can check the image of a finished customized article by using the user terminal apparatus of each of the users and logging in to the virtual reality space. It is thus possible to order the article without a complicated process of confirmation and the like between the plurality of users. Furthermore, since the customized article can be ordered via a network, a user does not need to go to a store, and therefore the ordering process is simple.

### BRIEF DESCRIPTION OF THE DRAWINGS

FIG. 1 shows general configuration of a network system for carrying out customized product sales service using an article ordering method according to an embodiment of the present invention;

FIG. 2 is a block diagram showing configuration of a user PC used by a user utilizing the customized product sales service;

FIG. 3 is a sequence flowchart illustrating processing operation of the user PC and a product order managing center when the user places an order in the customized product sales service;

FIG. 4 shows a screen displayed on the user PC when the user places an order in the customized product sales service;

FIG. 5 shows a screen displayed on the user PC when the user places an order in the customized product sales service;

FIG. 6 shows a screen displayed on the user PC when the user places an order in the customized product sales service;

FIG. 7 shows a screen displayed on the user PC when the user places an order in the customized product sales service;

FIG. 8 shows a screen displayed on the user PC when the user places an order in the customized product sales service;

FIG. 9 is a sequence flowchart illustrating processing operation of the user PC and the product order managing center when the user transmits customizing information to the product order managing center in the customized product sales service;

FIG. 10 shows a screen displayed on the user PC when the user inputs customizing information in the customized product sales service;

FIG. 11 is a sequence flowchart illustrating processing operation of the user PC and the product order managing center when the user places an order in the customized product sales service;

FIG. 12 shows a screen displayed on the user PC when the user places an order in the customized product sales service;

FIG. 13 shows a screen displayed on the user PC when the user places an order in the customized product sales service;

FIG. 14 shows a screen displayed on the user PC when the user places an order in the customized product sales service; and

FIG. 15 shows a screen displayed on the user PC when the user places an order in the customized product sales service.

### DETAILED DESCRIPTION OF THE PREFERRED EMBODIMENTS

Preferred embodiments of the present invention will hereinafter be described with reference to the drawings. Configuration of embodiment

A-1. General schematic configuration

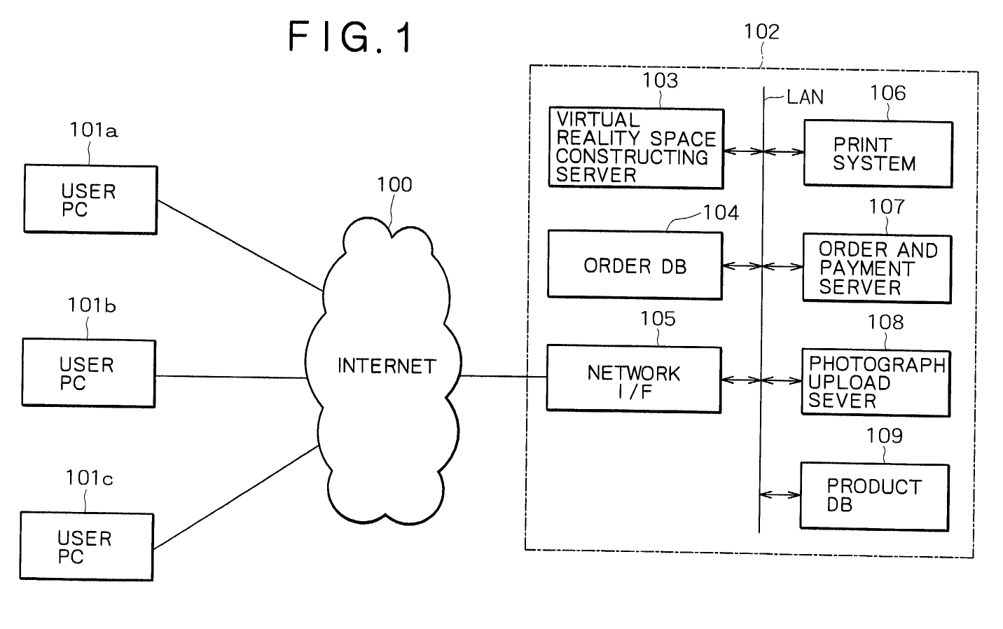

FIG. 1 shows general configuration of a network system for providing customized product sales service using an article ordering method according to an embodiment of the present invention. As shown in FIG. 1, in this network system, user PCs 101a, 101b, and 101c of a plurality of users (three users in the case of FIG. 1) using the customized product sales service are connected to an Internet 100 via a public telephone network or an Internet service provider not shown in the figure. Incidentally, in the description below, the user PCs 101a, 101b, and 101c will be referred to simply as a user PC 101 when there is no particular need to distinguish the user PCs 101a, 101b, and 101c from one another.

A product order managing center 102, which is a system for a provider that provides the customized product sales service, is also connected to the Internet 100. When the customized product sales service is carried out, various data is sent and received between the product order managing center 102 and the user PCs 101a, 101b, and 101c via the Internet 100.

In the customized product sales service provided in such a network system, a user uses the user PC 101 to place an order with the product order managing center 102 for a product customized by the user via the Internet 100, and then a product customized according to the order is fabricated and provided to the user. In providing the customized product sales service, a virtual reality space constructing server 103 within the product order managing center 102 provides the user PC 101, which has placed the order, with a virtual reality space displaying an image picture of a product specified by the user or a product customized according to an instruction from the user by three-dimensional graphics via the Internet 100. Therefore, by referring to the virtual reality space displaying a product on the user PC 101, the user can grasp the image of a customized product more accurately.

Prior to detailed description below of configuration of the user PC 101 and the product order managing center 102 for carrying out the customized product sales service, the virtual reality space will be described

A-2. Virtual reality space

Many services have been carried out to provide virtual reality space to user PCs and the like as described above, and a cyberspace (virtual reality space) service referred to as the Habitat (trademark) is known, for example. The Habitat began to be developed by LucasFilm of the US in 1985 and administered for about three years by QuantumLink, which is a US commercial network, and then the service of the Habitat was started as the Fujitsu Habitat (trademark) by NIFTY-Serve in February 1990. The Habitat enables a chat (text-based real-time conversation through input and display of characters) between users and the like by sending the other self of a user referred to as an avatar (an incarnation of a deity appearing in Hindu mythology) into a virtual city referred to as “Populopolis” rendered by two-dimensional graphics. For further detailed description of the Habitat, see “Cyberspace, Michael Benedikt, ed., 1^{st} ed. published on Mar. 20, 1994, NTT Publishing, ISBN4-87188-265-9C0010 (original; Cyberspace: First Steps, Michael Benedikt, ed. 1991, MITPressCambrige, MA ISBN0-262-02327-X) pp. 282 to 307.”

There are also services using description language for three-dimensional graphics data referred to as VRML (Virtual Reality Modeling Language) to display virtual reality space by three-dimensional graphics. Concrete examples of an infrastructure required to construct such three-dimensional virtual reality space considered at present include the Internet, which is a worldwide computer network connected by a communication protocol referred to as TCP/IP (Transmission Control Protocol/Internet Protocol) and an Intranet constructed by applying Internet technology such as WWW (World Wide Web) to information sharing on an intra-company LAN (Local Area Network). In addition, future use of a broadband network to be formed by FTTH (Fiber To The Home) for constructing an entire system including trunk line systems and subscriber line systems by using optical fibers is being considered.

The WWW (World Wide Web) developed by the CERN (European Center for Nuclear Research) of Switzerland is known as an information providing system enabling Internet use. The WWW allows information such as text, images, and sound to be accessed in a hypertext format. The WWW asynchronously transfers information stored in a WWW server terminal to a terminal such as a personal computer on the basis of a protocol referred to as HTTP (Hyper Text Transfer Protocol).

A WWW server comprises server software referred to as an HTTP (HyperText Transfer Protocol) daemon and an HTML file storing hypertext information. The hypertext information is represented by description language referred to as HTML (HyperText Markup Language). Hypertext description by HTML represents logical structure of text by format specification referred to as a tag enclosed by “<” and “>”. A link to other information is described by link information referred to as an anchor. A method of specifying a place where the information is present by an anchor is a URL (Uniform Resource Locator).

A protocol for transferring a file described by HTML on a TCP/IP network is HTTP (HyperText Transfer Protocol). The HTTP has a function of transmitting a request for information from a client to a WWW server and transferring hypertext information in an HTML file to the client.

Generally used as an environment for using the WWW is client software including Netscape Navigator (trademark of Netscape) and Internet Explorer (Microsoft) referred to as a WWW browser (a browser means viewing software).

Incidentally, the daemon means a program that effects control and processing in the background while work is performed on UNIX.

The description language for three-dimensional graphics data referred to as VRML enables description of three-dimensional space and setting of a hypertext link to an object rendered by three-dimensional graphics by further extending the WWW, and access to one WWW server terminal after another while following such links. Software for rendering virtual space described by the VRML on a personal computer or a workstation is a VRML browser. Such a VRML browser and software for servers to construct virtual reality space have been developed and commercialized as “Community Place (trademark) Browser/Bureau” by the present applicant of Sony Corporation, for example. Betas (samples) of the software can be downloaded from a home page “http://vs.sony.co.jp” on the Internet.

According to the present embodiment, the virtual reality space constructing server 103, which is a WWW server, generates information of a three-dimensional space described by the above-mentioned VRML to thereby construct a virtual reality space by three-dimensional graphics on the Internet 100. By using a VRML browser, the user PC 101 connected to the virtual reality space constructing server 103 via the Internet 100 can realize a function of displaying the virtual reality space constructed by three-dimensional graphics and the like.

A-3. User PC

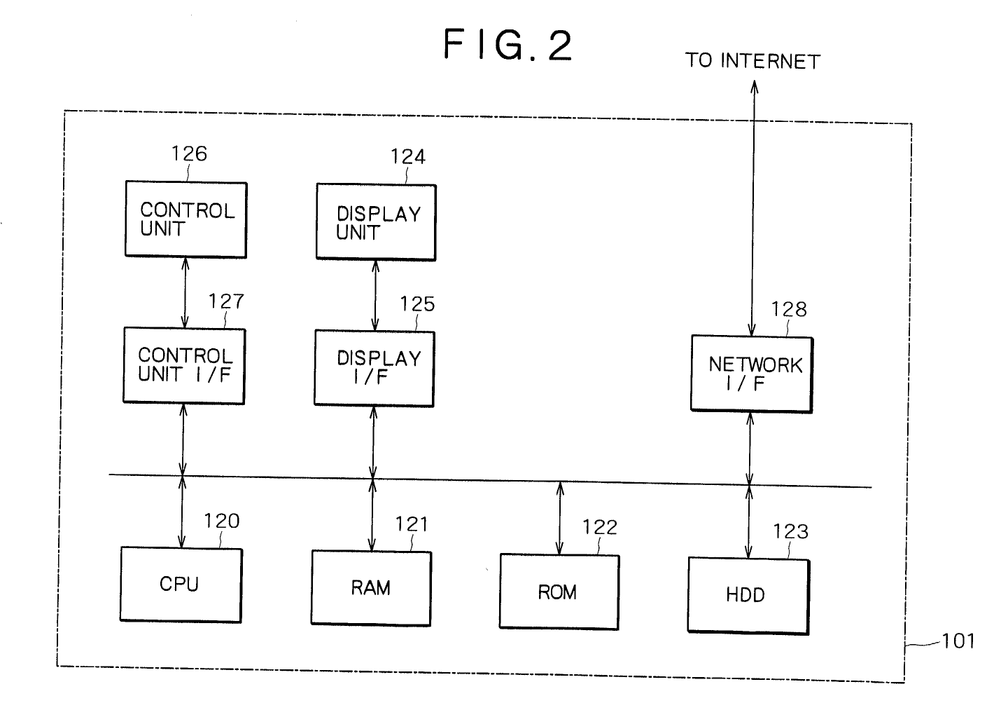

The user PC 101 will next be described with reference to FIG. 2. As shown in FIG. 2, the user PC 101 comprises: a CPU (Central Processing Unit) 120 for performing various arithmetic processing and controlling parts of the user PC 101; a RAM (Random Access Memory) 121 used as a work memory of the CPU 120; a ROM (Read Only Memory) 122 for storing a group of programs read and executed by the CPU 120; a hard disk 123 for storing a group of programs such as an operating system (for example “Windows 95/98/2000” (Microsoft)) and application programs read and executed by the CPU 120; a display unit 124 such as a liquid crystal display for displaying an image to the user; a display interface 125 for displaying an image based on data supplied from the CPU 120 on the display unit 124; a control unit 126 such as a keyboard, a mouse, a control button, and a rotary dial to be described later for input of an instruction by the user; a control unit interface 127 for supplying data representing the instruction inputted via the control unit 126 to the CPU 120; and a network interface 128 for sending and receiving data to and from an apparatus connected to the Internet 100 (see FIG. 1) via a telephone network or the like not shown in the figure. The hard disk 123 is read from and written to by the CPU 120, and is also used to store image data and various control data.

The CPU 120 executes various application programs stored in the ROM 122 and the hard disk 123 in response to turn-on of power not shown in the figure or an instruction of the user inputted by means of the control unit 126, whereby the user PC 101 can realize various functions. As described above, software such as a WWW browser and a VRML browser is installed on the hard disk 123 of the user PC 101, thereby enabling sending and receiving data in HTML (Hyper Text Markup Language) and VRML form to and from the product order managing center 102 via the Internet 100 (see FIG. 1). Thus, the user PC 101 can download three-dimensional graphics data of a Web page and a virtual reality space, which are rendered by the data in the above form, from the product order managing center 102 to thereby display the three-dimensional graphics data on the display unit 124.

A-4. Product order managing center

Returning to FIG. 1, the product order managing center 102 comprises the virtual reality space constructing server 103, an order database 104, a network interface 105, a print system 106, an order and payment server 107, a photograph upload server 108, and a product database 109, which are all connected to a LAN (Local Area Network). Each of the above-mentioned components of the product order managing center 102 can send and receive various data to and from the user PC 101 connected to the Internet 100 via the network interface 105.

As described above, the virtual reality space constructing server 103 can provide a virtual reality space constructed by three-dimensional graphics to the user PC 101 connected to the Internet 100. When the user orders a customized product onto which an image such as a photograph is to be copied, by transmitting information specifying the product from the user PC 101 to the product order managing center 102 via the Internet 100, the virtual reality space constructing server 103 constructs a virtual reality space displaying the specified product by three-dimensional graphics, and then provides the virtual reality space to the user PC 101 via the Internet 100 Specifically, the virtual reality space constructing server 103 newly generates VRML data for displaying the specified product by three-dimensional graphics, and then supplies the VRML data to the user PC 101 via the Internet 100. When the VRML data is received by the user PC 101, the virtual reality space displaying the user-specified product by three-dimensional graphics is displayed on the display unit 124 by a VRML browser of the user PC 101.

When picture information or the like to be copied onto the user-specified product is transmitted from the user PC 101 to the product order managing center 102 via the Internet 100, the virtual reality space constructing server 103 generates VRML data for displaying an image picture of the specified product with the picture information copied thereon, that is, a product customized by the user on the constructed virtual reality space, and then transmits the VRML data to the user PC 101 via the Internet 100. When the VRML data is received by the user PC 101, the virtual reality space displaying the user-customized product by three-dimensional graphics is displayed on the display unit 124 by a VRML browser of the user PC 101.

The order and payment server 107 performs processing for receiving an order from a user, and payment processing and the like when receiving an order in the customized product sales service provided by the product order managing center 102. The order and payment server 107 provides Web pages for a brief description of the customized product sales service to be supplied to the user PC 101 via the Internet 100 and for registration for membership and the like, and Web pages accessed when the customized product sales service is actually used.

Also, when the order and payment server 107 receives a request from the user PC 101 indicating an intention to purchase the product displayed by using the service (product specification in the present embodiment corresponds to the request), the order and payment server 107 issues a user ID and a password for each request (hereinafter referred to as order) . The order and payment server 107 writes, registers, and thus manages the issued user ID and password, the specified product, and customizing information, which will be described later, in the order database 104 for each order. When the user PC 101 thereafter transmits the user ID and the password to log in to the virtual reality space, the order and payment server 107 refers to contents registered in the order database 104 to thereby identify the product and the customizing information associated with the transmitted user ID and password, while the virtual reality space constructing server 103 constructs a virtual reality space on the basis of the product and the customizing information, and then provides the virtual reality space to the user PC 101 via the Internet 100.

The photograph upload server 108 is a server for uploading picture information such as a photograph that is desired by the user to be copied onto a part or the whole of a product. When the user PC 101 transmits such picture information via the Internet 100, the picture information is stored in the photograph upload server 108. The picture information is used for processing of generating an image picture of the product with the picture information copied thereon by the virtual reality space constructing server 103 and for copying a picture based on the picture information onto the product by the print system 106 after firm order is placed.

As described above, the print system 106 produces a customized product by copying the picture information such as a photograph transmitted by the user onto a specified portion of the product on the basis of determined order information when the print system 106 receives an order instruction from the user PC 101.

The product database 109 stores various information on products available in the customized product sales service, for example information such as a delivery date and a price of each of the products. The customized product sales service allows users not only to specify a product to be customized but also to search for a desired product by using information such as product genre, price, and delivery date. The product database 109 also stores information on a genre to which each product pertains and the like so as to enable the searches.

While functions of the servers and the like forming the product order managing center 102 have been described above, processing and the like of each of the components in carrying out the customized product sales service will be described in more detail in the following description of operations.

B. Operation of embodiment

Description will next be made of processing operation of the user PC 101 and the product order managing center 102 when the user of the user PC 101 utilizes the customized product sales service provided from the product order managing center 102 to the user PC 101 via the Internet 100 to order a customized product. In this case, the description will be made by taking, as an example, processing operation when users (owners of the user PCs 101a, 101b, and 101c) belonging to a group order one customized product.

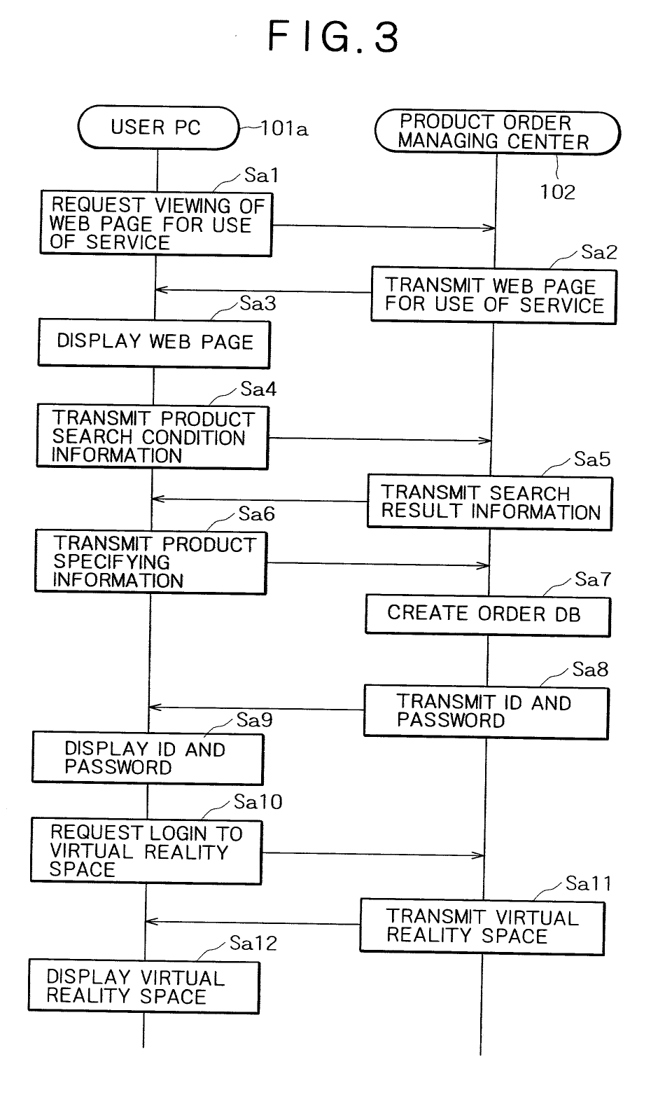

As shown in FIG. 3, when the users order a customized product, one user of the group (in this case the user will be referred to as a leader, and the leader is assumed to have the user PC 101a) appropriately operates the user PC 101a to transmit information requesting viewing of a Web page for using the service, or requesting viewing of a Web page from the order and payment server 107, from the user PC 101a to the product order managing center 102 via the Internet 100 (step Sa1). The appropriate operation in this case refers to an operation of making the user PC 101a perform processing for connection to the Internet 100 (dial-up connection processing, for example) by starting WWW browser software and specifying the URL of the Web page.

When the product order managing center 102 receives the information requesting viewing of a Web page thus transmitted from the user PC 101a via the Internet 100, the order and payment server 107 transmits the requested Web page to the user PC 101a via the Internet 100 (step Sa2). The Web page is displayed on the display unit 124 of the user PC 101a that has received the Web page transmitted from the product order managing center 102 (step Sa3).

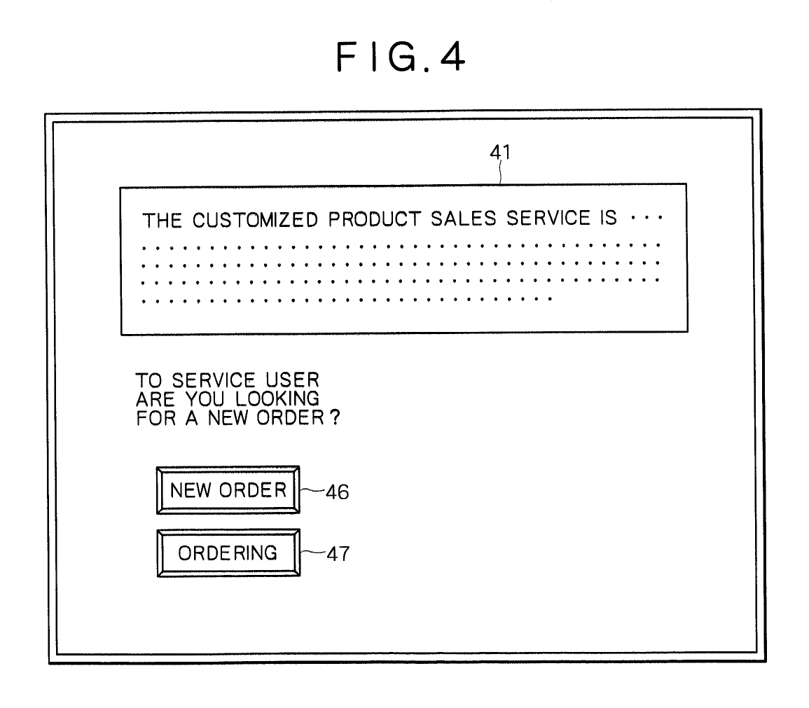

FIG. 4 shows an example of the Web page displayed on the display unit 124 of the user PC 101a. As shown in FIG. 4, the Web page shows a section 41 for brief description of the customized product sales service, as well as a new order button 46 and an ordering button 47 to be clicked when using the service. The new order button 46 is clicked when a product is to be newly specified and ordered after customization and the like. The ordering button 47 is clicked after a product is specified and ordered to log in to a virtual reality space formed for the order.

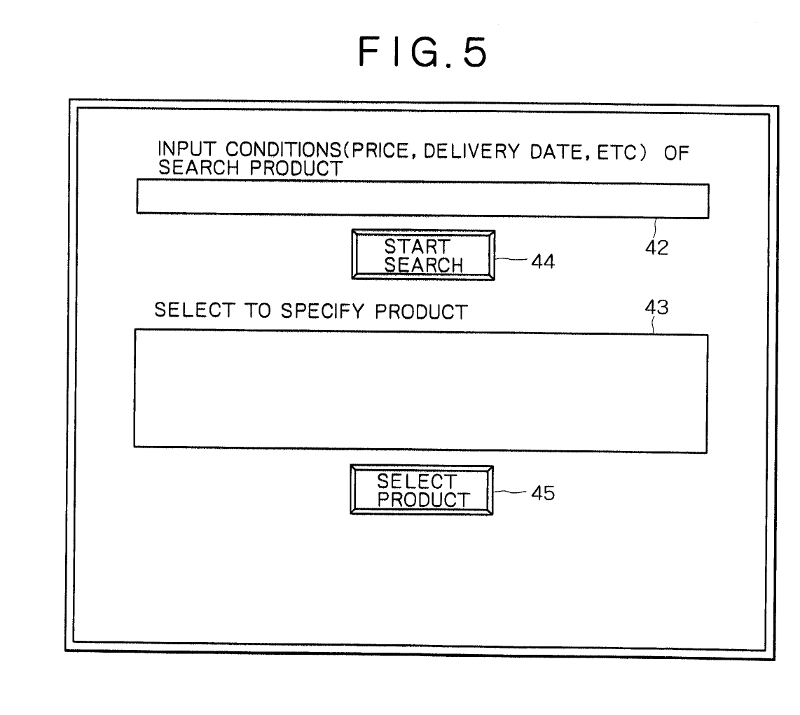

When the new order button 46 is clicked, the information is transmitted from the user PC 101a to the product order managing center 102 via the Internet 100. The order and payment server 107 thereby transmits a Web page for selecting a product. As shown in FIG. 5, the Web page for selecting a product shows a condition input section 42 for inputting product search conditions and a product input section 43 for inputting a specified product.

When a user has not decided a particular product to be specified, the customized product sales service allows the user to search for a product by inputting a desired price, a desired delivery date, and a desired product genre (for example, genres such as daily necessities and household electrical appliances) in the condition input section 42. When making such a search, the leader appropriately operates the control unit 126 of the user PC 101a to input search conditions in the condition input section 42, and then clicks a search start button 44. When the search conditions are thus inputted and then the search start button 44 is clicked, the conditions inputted in the condition input section 42 by means of the user PC 101a are filed as product search condition information, and then the file is transmitted to the order and payment server 107 of the product order managing center 102 via the Internet 100 (step Sa4).

When the search condition information is thus transmitted from the user PC 101a, the order and payment server 107 refers to the product database 109 to thereby search for a product matching the received search condition information. Then, a retrieved product (or retrieved products), that is, a search result is transmitted to the user PC 101a via the Internet 100 (step Sa5).

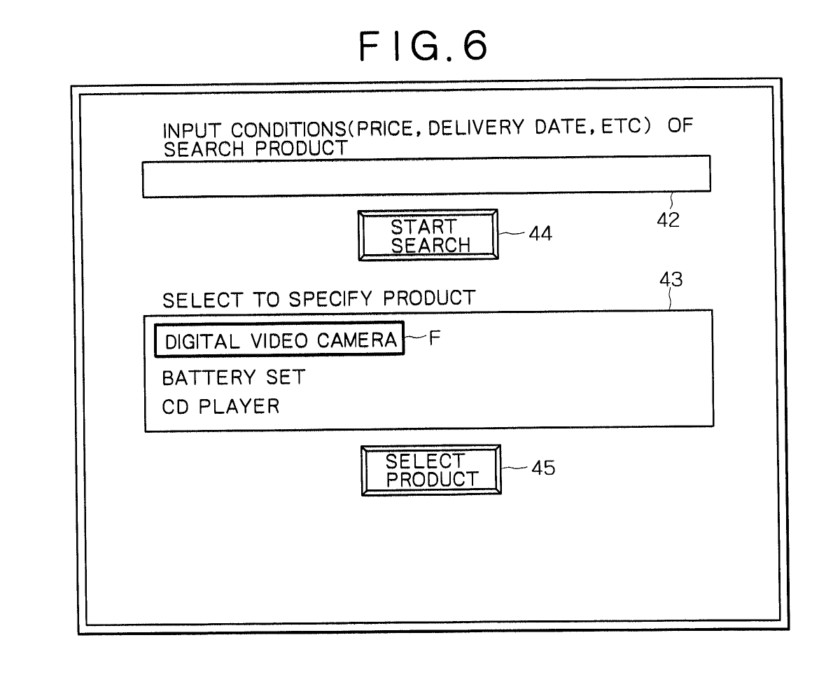

Receiving the search result transmitted from the order and payment server 107 of the product order managing center 102, the user PC 101a displays the search result on the display unit 124. Display methods in this case include, for example, a method of displaying retrieved products in an array in the product input section 43, as shown in FIG. 6. When specifying one of the retrieved products displayed in the product input section 43, the leader appropriately operates the control unit 126 of the user PC 101a to move a focus F to a product to be specified, and then clicks a product selection button 45. When the product selection button 45 is thus clicked, the user PC 101a generates product specifying information specifying the product enclosed by the focus F, and then transmits the product specifying information to the order and payment server 107 of the product order managing center 102 via the Internet 100 (step Sa6).

When the product order managing center 102 receives the product specifying information transmitted from the user PC 101a, the order and payment server 107 issues a user ID and a password for the product specifying request, that is, the order, and then writes and registers the issued user ID, password and the specified product in the order database 104 in association with the order (step Sa7). Then, the order and payment server 107 transmits the issued user ID and password to the user PC 101a, the transmitter of the product specifying information, via the Internet 100 (step Sa8). Thus, the user ID and the password are not those issued to some user, but information issued in association with an order, or a product specifying request and used for authentication processing at the time of log-in to a virtual reality space formed for the order. When information such as a user ID and a password is thus issued for each order and given to other users, the users who know the information are allowed to log in to the virtual reality space formed for the order. In other words, those who do not know the user ID and the password of the order, that is, outsiders are not allowed to log in to the virtual reality space for the order. It is thus possible to prevent outsiders from viewing an image of a customized product being ordered.

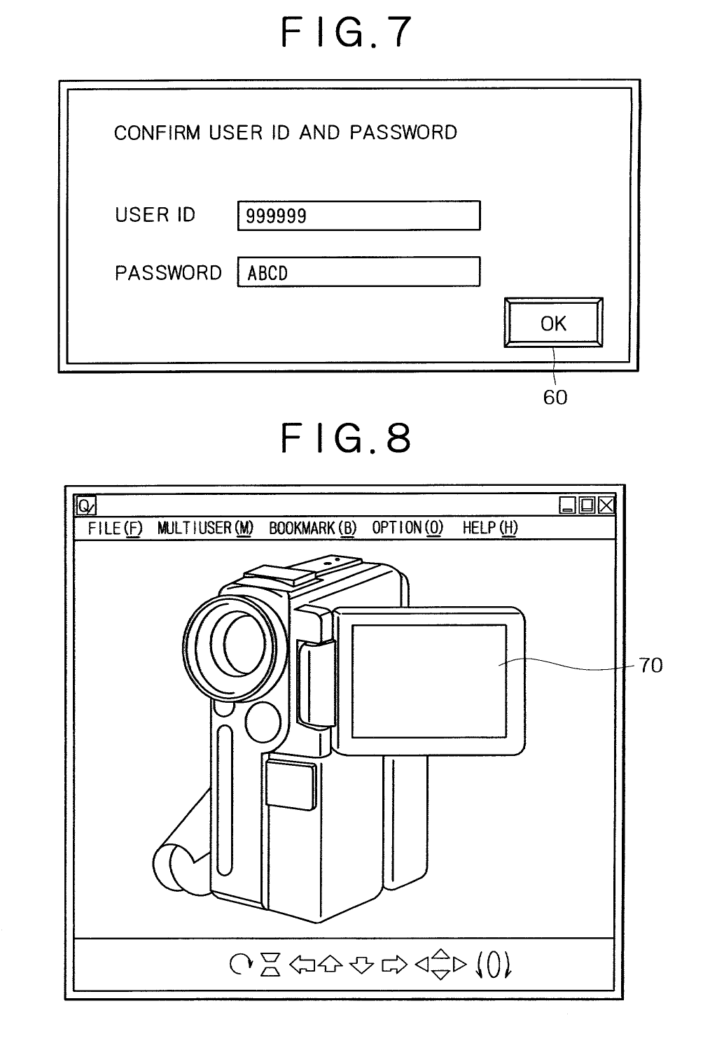

After the user ID and the password are transmitted from the product order managing center 102, the user ID and the password are displayed on the display unit 124 of the user PC 101a as shown in FIG. 7 (step Sa9). Since the user ID and the password are information necessary for logging in to the virtual reality space as described above, the leader writes down the information and also notifies the owners of the user PCs 101b and 101c (hereinafter referred to as other users) belonging to the group of the information. While the notifying method in this case is arbitrary and therefore the leader may notify the other users by telephone or the like, service may be carried out which allows electronic mail address information of the other users to be notified of the user ID and the password to be transmitted together with the product specifying information when the user PC 101a transmits the product specifying information to the product order managing center 102, and allows the product order managing center 102 that has received the electronic mail address information to transmit electronic mail including the user ID and the password to the electronic mail addresses.

When the leader, having confirmed the user ID and the password displayed on the display unit 124, operates the control unit 126 to click an OK button 60 shown in FIG. 7, the user PC 101a transmits information requesting log-in to the virtual reality space displaying the specified product to the product order managing center 102 via the Internet 100 (step Sa10). The log-in requesting information includes the user ID and the password.

When the log-in requesting information is transmitted from the user PC 101a to the product order managing center 102, the virtual reality space constructing server 103 compares the user ID and the password included in the log-in requesting information with contents registered in the order database 104, and thus performs authentication processing for determining whether the log-in is to be authenticated or not depending on whether the transmitted user ID and password are registered or not. When it is determined as a result of the authentication processing that the user ID and the password are registered and therefore the log-in is authenticated, the virtual reality space constructing server 103 constructs a virtual reality space displaying the specified product registered in the order database 104 by three-dimensional graphics, and then transmits the constructed virtual reality space, that is, transmits VRML data of the virtual reality space to the user PC 101a via the Internet 100 (step Sa11).

The display unit 124 of the user PC 101a that has received the VRML data thus transmitted from the virtual reality space constructing server 103 displays the virtual reality space displaying the specified product (digital video camera in this case) by three-dimensional graphics, as shown in FIG. 8 (step Sa12). The product displayed in the virtual reality space at this point is of course a non-customized product, and thus a copy candidate area 70 of the product in which picture information such as a photograph can be copied is displayed as shown in FIG. 8. While only one copy candidate area 70 is shown in FIG. 8, a plurality of copy candidate areas 70 may be provided. Since the product is displayed in the virtual reality space, an angle from which the product is viewed and the like can be changed.

Referring to the product thus displayed in the virtual reality space, a user selects a copy candidate area 70 in which a picture such as a photograph is to be copied, determines which picture information to copy in the selected copy candidate area 70, and then places an order.

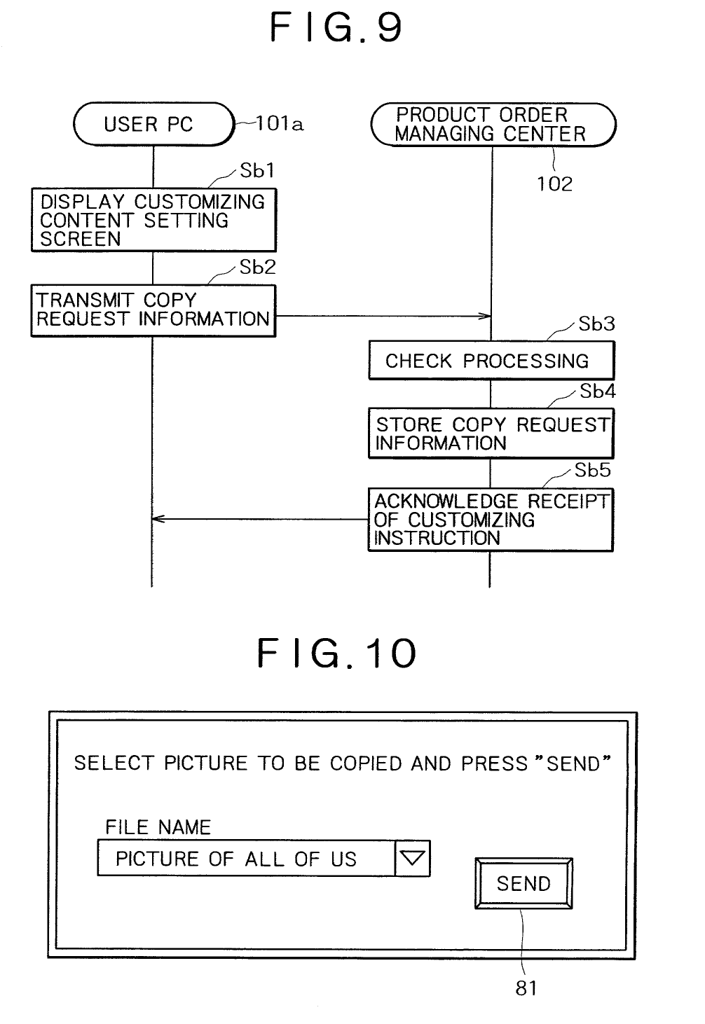

At this point, referring to the virtual reality space thus displayed on the display unit 124 of the user PC 101a, the leader makes customization such as selecting a copy candidate area 70 and selecting picture information such as a photograph to be copied. Of course, at this point, other users may log in to the virtual reality space by using the user ID and the password, and make customization. However, process operations when the leader proceeds to make customization while referring to the virtual reality space displayed on the display unit 124 of the user PC 101a as described above will be described below with reference to FIG. 9. Incidentally, it is possible for the leader to disconnect the user PC 101a from the product order managing center 102 and thereafter access the product order managing center 102 again to perform customization processing.

The leader appropriately operates the user PC 101a to select a copy candidate area 70. The selecting operation in this case is the selecting of a desired copy candidate area 70 from a copy candidate area 70 displayed in the virtual reality space (while only one copy candidate area 70 is shown in FIG. 8, there may be a plurality of copy candidate areas 70 in some cases) with a click of a mouse, for example. When the leader performs such operation, the user PC 101a displays on the display unit 124 a screen prompting the leader to input the picture information to be copied, as shown in FIG. 10 (step Sb1). A picture information input section 80 for inputting the picture information to be copied is a pull-down menu allowing selection of picture information stored on the hard disk 123 of the user PC 101a and picture information stored on a floppy disk or a CD-ROM (Compact Disc-Read Only Memory) that is set in an external storage device incorporated in the user PC 101a.

When the leader selects the picture information to be copied and then clicks a transmission button 81, the user PC 101a transmits copy request information (customizing information) including copy position specifying information specifying the copy candidate area 70 selected in a manner as described above and the selected picture information to the product order managing center 102 via the Internet 100 (step Sb2).

Receiving the copy request information thus transmitted from the user PC 101a via the Internet 100, the photograph upload server 108 checks the received copy request information for a defect and the like (step Sb3). The photograph upload server 108 checks whether the copy candidate area 70 is specified and whether the uploaded picture information is data in a format handled in the service (for example BMP (Bit Map) or JPEG (Joint Photographic Experts Group)). When a defect is found as a result of the check, information for notifying the defect is transmitted to the user PC 101a and the leader is prompted to provide an input again.

When no defect is found as a result of the check, the photograph upload server 108 stores the copy request information and also stores address information for accessing the picture information and the copy position information in the order database 104 in association with the order (step Sb4). Then, the photograph upload server 108 transmits information for notifying the leader that an instruction for customization such as the copying of a picture is received to the user PC 101a via the Internet 100 (step Sb5).

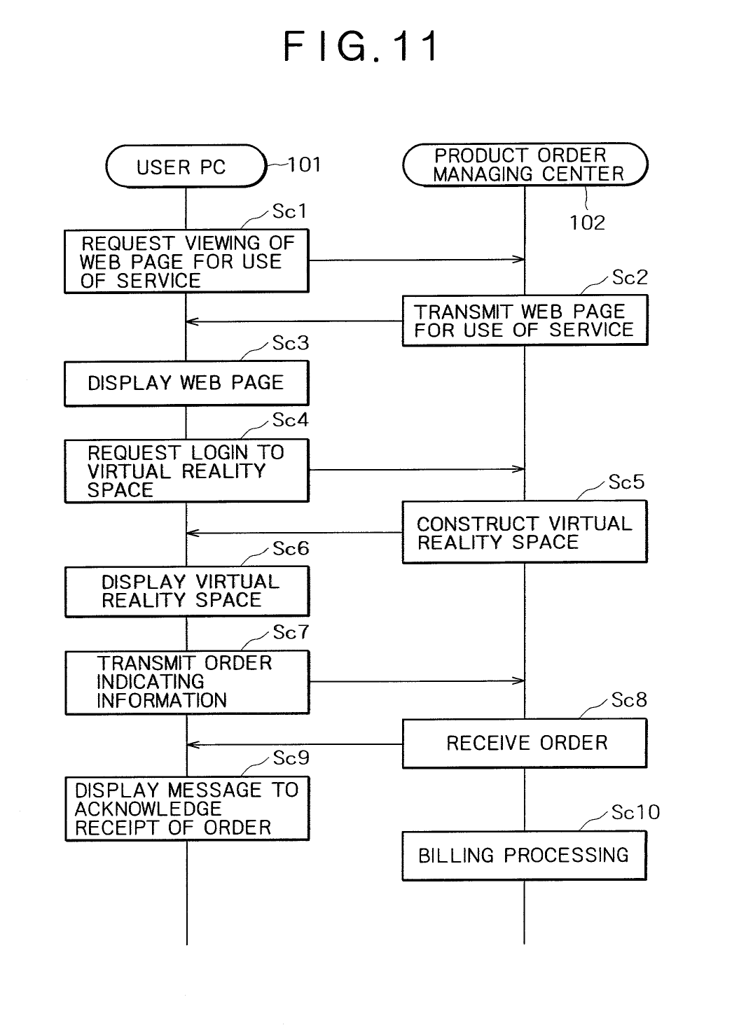

As described above, the customized product sales service allows a user to log in to the virtual reality space displaying the customized product by three-dimensional graphics after the copy request information is transmitted from the user PC 101a to the product order managing center 102. By using the user ID and the password, it is possible to log in to the virtual reality space and then check an image of the customized product before placing an order. Process operations when logging in to the virtual reality space displaying the customized product, checking an image of the customized product while referring to the virtual reality space, and thereafter placing an order will be described below with reference to FIG. 11. Incidentally, since a procedure and the like for placing an order to be described below can be carried out not only by the leader but also by the other users using the user ID and the password, one who carries out ordering processing will hereinafter be referred to simply as a user, and a terminal apparatus used by the user will be referred to as a user PC 101.

First, as in the case of a new order described above, information requesting viewing of a Web page for using the service is transmitted (step Sc1). The appropriate operation in this case refers to an operation of making the user PC 101 perform processing for connection to the Internet 100 (dial-up connection processing, for example) by starting WWW browser software and specifying the URL of the Web page.

When the product order managing center 102 receives the information requesting viewing of a Web page thus transmitted from the user PC 101 via the Internet 100, the order and payment server 107 transmits the requested Web page to the user PC 101 via the Internet 100 (step Sc2). The Web page is displayed on the display unit 124 of the user PC 101 that has received the Web page transmitted from the product order managing center 102 (step Sc3).

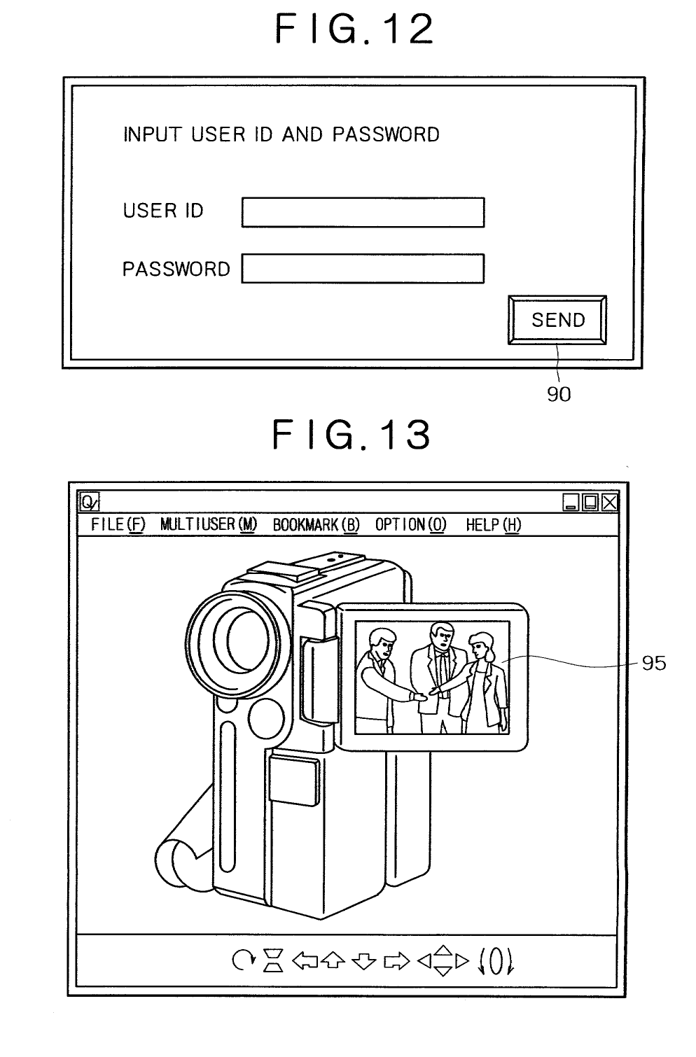

The Web page as shown in FIG. 4 is displayed on the display unit 124 of the user PC 101, and the ordering button 47 is clicked in this case. When the ordering button 47 is clicked, the information is transmitted from the user PC 101 to the order and payment server 107 of the product order managing center 102 via the Internet 100. The order and payment server 107 thereby transmits a Web page prompting for input of the user ID and the password to the user PC 101 via the Internet 100. A screen prompting for input of the user ID and the password as shown in FIG. 12 is displayed on the display unit 124 of the user PC 101.

When the user inputs the user ID and the password, and then clicks a transmission button 90, the user PC 101 transmits log-in request information including the inputted user ID and password to the product order managing center 102 via the Internet 100 (step Sc4). When the log-in request information is thus transmitted from the user PC 101, the virtual reality space constructing server 103 searches the order database 104 for an order corresponding to the user ID and the password included in the log-in request information. When an order corresponding to the user ID and the password is found, the virtual reality space constructing server 103 constructs a virtual reality space corresponding to the log-in request information (step Sc5). When an order corresponding to the user ID and the password is not found in the order database 104, on the other hand, the log-in is not allowed. Thus, those who do not know the user ID and the password, that is, outsiders not concerned with the order are not allowed to log in to the virtual reality space formed for the order.

The virtual reality space constructing server 103 constructs the virtual reality space by referring to contents registered in the order database 104 and the like. Specifically, the virtual reality space constructing server 103 refers to the order database 104 to obtain information on the product pertinent to the order and information on whether a user has made customization (specification of a copy position and specification of picture information to be copied). When an instruction for customization has been issued, the virtual reality space constructing server 103 obtains information on the copy position and the picture information to be copied from the photograph upload server 108. Using the thus obtained product, copy position, and picture information to be copied, the virtual reality space constructing server 103 constructs a virtual reality space displaying the product customized according to customizing instructions from the user by three-dimensional graphics. The virtual reality space constructing server 103 transmits the constructed virtual reality space to the user PC 101, which requested log-in, via the Internet 100. Thus, according to the present embodiment, the virtual reality space constructing server 103 constructs a virtual reality space every time log-in is requested. Therefore, load on the virtual reality space constructing server 103 can be made lighter than when the virtual reality space constructing server 103 retains virtual reality spaces for many orders regardless of whether there is log-in or not.

The display unit 124 of the user PC 101 that has received the virtual reality space displaying the customized product and thus transmitted from the virtual reality space constructing server 103 via the Internet 100 displays the virtual reality space displaying the product with a picture corresponding to the specified picture information copied at the specified copy position by three-dimensional graphics, as shown in FIG. 13 (step Sc6). In the example shown in FIG. 13, a picture 95 is copied on the back of a liquid crystal display portion of the digital video camera.

By referring to an image of the customized product thus displayed by three-dimensional graphics, a user can grasp an image of a finished product more accurately, and determine whether or not to place an order on the basis of the accurately grasped image. The virtual reality space is formed for each order, as described above, and is a shared virtual reality space to which other users (members of the group) who know the user ID and the password of the order can log in simultaneously with the user currently logging in. Therefore, a plurality of users can check the image of the finished product simultaneously, have a conversation (so-called a chat) using the virtual reality space shared by the users, and thus consult with each other as to whether to place an order while referring to the image of the finished product. For example, by appropriately operating the user PC 101 and using the virtual reality space, a user can decide whether to place an order by a majority vote taken by the users currently logging in to the virtual reality space.

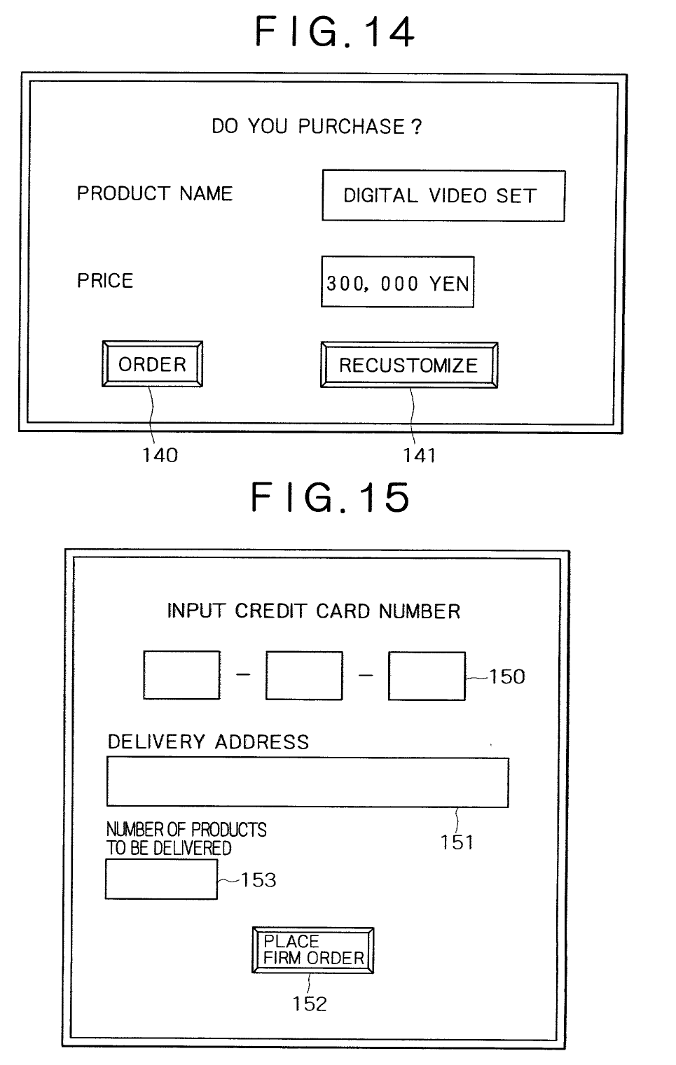

After checking the image of the customized product displayed on the display unit 124 of the user PC 101, as described above, the user appropriately operates the control unit 126 to issue an instruction for placing an order or recustomization. A method for issuing the instruction in this case is the clicking of either one of an order button 140 and a recustomization button 141 displayed together with a product name and a price on the screen as shown in FIG. 14, for example. When recustomization is to be made, the user clicks the recustomization button 141 to transmit an instruction for recustomization from the user PC 101 to the product order managing center 102 via the Internet 100. In this case, the customizing information registered in the order database 104 is erased, and also the picture information uploaded to the photograph upload server 108 is erased. Then, the virtual reality space constructing server 103 constructs a virtual reality space displaying the product before customization, and supplies the virtual reality space to the user PC 101.

When the user clicks the order button 140 to issue an instruction for placing an order, on the other hand, the display unit 124 of the user PC 101 displays a number input section 150 for inputting a credit card number used for payment of the purchased product, a delivery address input section 151, and a delivery quantity input section 153, as shown in FIG. 15. After input in the number input section 150, the delivery address input section 151, and the delivery quantity input section 153 and the clicking of a firm order button 152, the user PC 101 transmits order indicating information including the credit card number to the product order managing center 102 via the Internet 100 (step Sc7). Incidentally, while one delivery address input section 151 and one delivery quantity input section 153 are shown in FIG. 15, a plurality of delivery address input sections 151 and delivery quantity input sections 153 may be displayed to specify a plurality of delivery addresses. Also, the service employing a membership system allows the input on the screen to be omitted if a credit card number and a delivery address are inputted in advance at the time of registration for membership.

When the order indicating information is transmitted from the user PC 101, the order and payment server 107 accesses a credit server of a credit company to determine whether the credit card number included in the order indicating information is valid or not. When it is determined that the credit card number is valid, the order and payment server 107 generates firm order data for the order on the basis of the product and customizing information registered in the order database 104, and thereby receives the order for the customized product (step Sc8). The order and payment server 107 then transmits information for notifying the user of receipt of the order to the user PC 101 via the Internet 100. The display unit 124 of the user PC 101 thereby displays a receipt message notifying the receipt of the order from the user (step Sc9). The order and payment server 107 also carries out billing processing based on the information of the firm order (step Sc10). Thereafter, the print system 106 copies the picture onto the product on the basis of the firm order data generated as described above, and produces the number of user-customized products which number is inputted in the delivery quantity input section 153, and then the customized product or products are delivered to one or more delivery addresses inputted in the delivery address input section 151 as described above.

Thus, the user can receive the product customized by the user or the group to which the user belongs. As described above, the image of the finished customized product received by the user has been checked in a realistic picture such as a three-dimensional graphics picture, and therefore the customized product actually delivered to the user will not differ greatly from a product imagined by the user. Therefore, a user making use of the service will not be concerned that a product actually delivered to the user might differ greatly from what the user imagines, and therefore the user will not hesitate to place an order for an expensive product because the user cannot imagine a finished product. In addition, the present embodiment allows an image of a finished product to be grasped more accurately before placing an order, and in this case the image of a finished product is represented by picture data. It is therefore unnecessary to employ a complicated, expensive method such as actually making a trial product to be checked.

C. Modifications

It is to be noted that the present invention is not limited to the foregoing embodiment, and is susceptible of various modifications illustrated below.

(First Modification)

According to the foregoing embodiment, billing processing is carried out for each product when a user places an order for the product after specifying the product, transmitting customizing information, and checking the customized product in a virtual reality space; however, billing processing may be carried out for each virtual reality space constructed by the virtual reality space constructing server 103. For example, the order and payment server 107 may carry out billing processing for a product ordered, as in the foregoing embodiment, and may also bill, as a charge for use of the service, each virtual reality space constructed when a user requests log-in to the virtual reality space to check a customized product. In this case, the order and payment server 107 may count the number of log-ins, calculate a total service use charge by multiplying a charge per log-in for using log-in service by the number of log-ins, and then perform billing processing for the total service use charge in conjunction with a charge for a product after a firm order for the product is placed. In order to omit operation such as input of a credit card number in each log-in request, a method may be employed which prompts a user to input a credit card number only at the time of a new order, or prompts the user to input the credit card number only at the time of registration for membership when a membership system is employed for the service.

In addition, while according to the foregoing embodiment, billing processing using a credit card is performed, other methods may be employed. For example, when a message to acknowledge receipt of an order is displayed after receiving the order from a user, an account number and the like of the service provider may be displayed to prompt the user to transfer the charges to the account. In this case, the operation of producing a customized product by the print system 106 and the operation of shipping the customized product may be performed after confirming that the user has transferred the specified charges to the account.

(Second Modification)

While the foregoing embodiment has dealt with the customization of copying a picture such as a photograph onto a product such as a digital video camera, another customizing method may be employed which copies a picture such as a photograph onto a package (a box, wrapping, or the like) of a product such as a digital video camera rather than the product itself. Also, the present invention is not limited to customizing methods for copying a picture onto an article; methods for customizing shape, color or the like of a product may be employed.

(Third Modification)

The foregoing embodiment has dealt with a case where programs for carrying out processing for the customized product sales service as described above are preinstalled in the servers and the like of the product order managing center 102 such as the virtual reality space constructing server 103 and the order and payment server 107. However, the present invention is not limited to this. The programs may be installed by playing a program storage medium formed by a package medium such as a CD-ROM or a DVD-ROM (Digital Versatile Disc-Read Only Memory) that stores the programs. Alternatively, the programs may be installed by playing a program storage medium such as a semiconductor memory or a disk that temporarily or permanently stores the programs.

The programs may be stored on the program storage media by using wired and wireless communication media such as a local area network and digital satellite broadcasting, or may be stored via various communication interfaces such as a router and a modem.

(Fourth Modification)

While in the foregoing embodiment, a user utilizes the customized product sales service using the user PC 101, a user may use a terminal apparatus having functions of a WWW browser and a VRML browser, as well as a PC. For example, a user may use a portable telephone having functions of a WWW browser and a VRML browser.

As described above, according to the present invention, it is possible to order a customized article easily, enable an image of the customized article to be grasped more accurately by the orderer, and simplify operations when the article is customized jointly by a plurality of users.

What is claimed is:

1. An article ordering method for placing an order for an article customized by users of a plurality of user terminal apparatus connected to a network with an article order managing system having a virtual space providing server for providing a virtual reality space to a plurality of said user terminal apparatus via said network, said method comprising:
a customizing information transmitting step for transmitting customizing information for customizing the article from said user terminal apparatus to said article order managing system via said network;
a customized picture generating step for generating, in said virtual space providing server, picture information of a virtual reality space displaying the article customized on the basis of the received customizing information when said article order managing system receives said customizing information;
a customized article picture transmitting step for transmitting the generated picture information from said virtual space providing server via said network to said user terminal apparatus that have logged in to said virtual reality space, and thereby displaying said virtual reality space displaying the customized article on said user terminal apparatus to prompt for an order for the customized article; and
an ordering step for transmitting order indicating information indicating the order for the article displayed in said virtual reality space from said user terminal apparatus to said article order managing system via said network.

2. An article ordering method as claimed in claim 1, further comprising:
an article specifying step for transmitting article specifying information specifying one of a plurality of articles provided in advance in said article order managing system from said user terminal apparatus to said article order managing system via said network;
an article picture generating step for generating, in said virtual space providing server, the picture information of said virtual reality space displaying the article specified by said article specifying information when said article order managing system receives said article specifying information from said user terminal apparatus; and
a specified article picture transmitting step for transmitting the generated picture information from said virtual space providing server via said network to said user terminal apparatus that have logged in to said virtual reality space, and thereby displaying said picture information on said user terminal apparatus to prompt for input of said customizing information.

3. An article ordering method as claimed in claim 2,
wherein said virtual space providing server forms a virtual reality space for displaying the article specified by said article specifying information each time said virtual space providing server receives said article specifying information from said user terminal apparatus via said network.

4. An article ordering method as claimed in claim 3, further comprising a billing step for performing billing processing for a user of said user terminal apparatus by using the virtual reality space formed by said virtual space providing server as a unit.

5. An article ordering method as claimed in claim 1, further comprising an authentication step for performing authentication processing in said article order managing system to determine whether log-in is allowed to said user terminal apparatus requesting the log-in to said virtual reality space for displaying the article via said network.

6. An article ordering method as claimed in claim 1, wherein said network is an Internet.

7. An article ordering method as claimed in claim 1,
wherein said customizing information includes copying picture information for copying onto a part or a whole of the article; and
said customized picture generating step generates the picture information of said virtual reality space displaying the article with a picture corresponding to said copying picture information copied on the part or the whole of the article.

8. An article ordering method as claimed in claim 1,
wherein the picture information of said virtual reality space generated at said customized picture generating step is picture information displaying the customized article three-dimensionally.

9. An article order managing apparatus having a function of providing a virtual reality space to a plurality of user terminal apparatus via a network for receiving an order for an article from said user terminal apparatus, said article order managing apparatus comprising:
receiving means for receiving customizing information for customizing the article, said customizing information being transmitted from said user terminal apparatus via said network;
customized picture generating means for generating picture information of a virtual reality space displaying the article customized on the basis of said customizing information received by said receiving means;
customized article picture transmitting means for transmitting the picture information of said virtual reality space generated by said customized picture generating means to said user terminal apparatus that have logged in to said virtual reality space, via said network; and
order receiving means for receiving order indicating information indicating the order for the customized article displayed in said virtual reality space and thereby receiving the order, said order indicating information being transmitted from said user terminal apparatus via said network.

10. An article order managing apparatus as claimed in claim 9, further comprising:
an article database for storing picture information of a plurality of articles for displaying an article in said virtual reality space;
specifying information receiving means for receiving article specifying information specifying one of said plurality of articles, said article specifying information being transmitted from said user terminal apparatus via said network;
article picture generating means for generating the picture information of said virtual reality space displaying the article specified by said article specifying information received by said specifying information receiving means, by referring to said article database; and
specified article picture transmitting means for transmitting the picture information generated by said article picture generating means to said user terminal apparatus that have logged in to said virtual reality space, via said network.

11. An article order managing apparatus as claimed in claim 10,
wherein said article order managing apparatus generates picture information for forming a virtual reality space for displaying the article specified by said article specifying information each time said article order managing apparatus receives said article specifying information from said user terminal apparatus via said network.

12. An article order managing apparatus as claimed in claim 10, further comprising billing means for performing billing processing for a user of said user terminal apparatus by using, as a unit, said virtual reality space formed each time said article order managing apparatus receives said article specifying information from said user terminal apparatus via said network.

13. An article order managing apparatus as claimed in claim 9, further comprising authentication means for performing authentication processing to determine whether log-in is allowed to said user terminal apparatus requesting the log-in to said virtual reality space for displaying the article via said network.

14. An article order managing apparatus as claimed in claim 9,
wherein said customizing information includes copying picture information for copying onto a part or a whole of the article; and
said customized picture generating means generates the picture information of said virtual reality space displaying the article with a picture corresponding to said copying picture information copied on the part or the whole of the article.

15. An article order managing apparatus as claimed in claim 9,
wherein said customized picture generating means generates the picture information of said virtual reality space displaying the customized article three-dimensionally.

16. A program storage medium for storing a program to be executed by an article order managing apparatus, said article order managing apparatus having a function of providing a virtual reality space to a plurality of user terminal apparatus via a network for receiving an order for an article from said user terminal apparatus, said program comprising:
a receiving process step for receiving customizing information for customizing the article, said customizing information being transmitted from said user terminal apparatus via said network;
a customized picture generating process step for generating picture information of a virtual reality space displaying the article customized on the basis of said customizing information received at said receiving process step;
a customized article picture transmitting process step for transmitting the picture information of said virtual reality space generated at said customized picture generating process step to said user terminal apparatus that have logged in to said virtual reality space, via said network; and
an order receiving process step for receiving order indicating information indicating the order for the customized article displayed in said virtual reality space and thereby receiving the order, said order indicating information being transmitted from said user terminal apparatus via said network.
